(19) United States
(12) Patent Application Publication
(10) Pub. No.: US 2024/0168212 A1
(43) Pub. Date: May 23, 2024

(54) COMPOSITE DIFFRACTION ELEMENT, IMAGE DISPLAY DEVICE, AND METHOD FOR MANUFACTURING COMPOSITE DIFFRACTION ELEMENT

(71) Applicant: SONY SEMICONDUCTOR SOLUTIONS CORPORATION, KANAGAWA (JP)

(72) Inventor: YUKIHIKO UOTA, KANAGAWA (JP)

(21) Appl. No.: 18/550,976

(22) PCT Filed: Jan. 19, 2022
(86) PCT No.: PCT/JP2022/001736

§ 371 Date: Sep. 18, 2023

(30) Foreign Application Priority Data
Mar. 29, 2021 (JP) 2021-055944

(51) Int. Cl. G02B 5/32; G02B 5/18; G02B 27/02

(52) U.S. Cl. CPC G02B 5/32; G02B 5/1861; G02B 27/028

(57) ABSTRACT

To provide a composite diffraction element capable of preventing nonuniformity of an image due to, for example, a bubble and improving quality. A composite diffraction element 100 includes: at least two diffraction elements 101 and 102 each having a reflection surface that reflects light; and a support body 103 placed between each of the diffraction elements 101 and 102, the support body 103 having a void 108, and each of the diffraction elements 101 and 102 are placed, facing each other across the void 108. Furthermore, in the composite diffraction element 100, the diffraction elements 101 and 102 are reflective diffraction elements, and transmit projected light while diffracting the projected light selectively. The diffraction elements 101 and 102 are volume hologram elements having protective layers 104 and 106, and photosensitive material layers 105 and 107 on each of which the reflection surface is formed.

### TECHNICAL FIELD

The present technology relates to a composite diffraction element including a plurality of diffraction elements each having a light reflection surface, an image display device, and a method for manufacturing the composite diffraction element.

### BACKGROUND ART

There is conventionally known an image display device (eyewear) such as a head mounted display (HMD) of a type that projects a projection light beam diffracted by a hologram lens directly onto the retina of an observer through the pupil from a light source placed in front of the observer.

In a volume hologram lens that is used in such an image display device and configures a diffraction element, a photosensitive material is very thin in thickness, from several μm to several dozen μm. Even in a case of including a sheet that protects the photosensitive material, the photosensitive material does not have sufficient strength by itself. As a result, it is difficult for the photosensitive material to stably stand on its own and to undergo interference exposure. Therefore, in general, a state where the photosensitive material is coated on or affixed to a material (glass or transparent plastic) that is optically transparent and has strength at a certain level or above is prepared to perform interference exposure.

Furthermore, it is still difficult for the diffraction element itself to stand on its own even after exposure. Therefore, in general, the diffraction element is provided, similarly affixed to an optically transparent support material also when applied to a product in the end. As an example, eyewear is known for which the process is stabilized and simplified by using a support material for interference exposure also as a support material for the product. In this eyewear, a holding material also serves as a light guide plate. However, a plurality of holograms is physically spaced a certain distance apart. As a result, diffraction elements of the plurality of holograms do not interfere with each other when the diffraction elements are produced.

On the other hand, in a case of considering a composite diffraction element that transmits an incident light beam while having wavelength and angular selectivity by combining two reflective diffraction elements, the two diffraction elements are required to be placed in such a manner that respective reflection surfaces thereof face each other and are close to each other.

For example, Patent Document 1 proposes a holographic optical element that is obtained by superimposing a transmissive hologram and a reflective hologram, does not generate light of unnecessary diffraction orders and, in addition, is usable as both a transmissive type and a reflective type.

### CITATION LIST

### Patent Document

Patent Document 1: Japanese Patent Application Laid-Open No. 05-232320

### SUMMARY OF THE INVENTION

### Problems to be Solved by the Invention

However, in the technology of Patent Document 1, it is necessary to provide grating spacing pitches, which are different according to interference exposure, to a first diffraction grating and a second diffraction grating. However, the first diffraction grating and the second diffraction grating are placed close to each other and hence they influence each other while the first diffraction grating and the second diffraction grating are simultaneously affixed to a support body. As a result, exposure is difficult. Therefore, a process is required in which an unexposed diffraction element is once affixed to or coated on a temporary holding material different from the product, interference exposure is performed thereon, and then the diffraction element is reaffixed to a final holding material.

During this peeling and reaffixing operation, minute dust may be mixed in between the diffraction element and the holding material, or a partial distortion or warp in the shape may occur when a flexible photosensitive material is affixed. As a result, an optical connection between the holding material and the photosensitive material may be partially broken.

As a consequence, a main object of the present technology is to provide a composite diffraction element capable of preventing nonuniformity of an image due to, for example, a bubble and improving quality.

### Solutions to Problems

The present technology provides a composite diffraction element including: at least two diffraction elements each having a reflection surface that reflects light; and a support body placed between the diffraction elements, the support body having a void, in which each of the diffraction elements are placed, facing each other across the void.

Furthermore, the present technology provides an image display device including: at least two diffraction elements on each of which a reflection surface that reflects light is formed; a support body placed between the diffraction elements, the support body having a void; and an image forming unit, in which each of the diffraction elements are placed, facing each other across the void.

Furthermore, the present technology provides a method for manufacturing a composite diffraction element, the method including the steps of: affixing a first diffraction element to a first holding material and affixing a second diffraction element to a second holding material; exposing the first diffraction element affixed to the first holding material; exposing the second diffraction element affixed to the second holding material; forming a void in a support body supporting the first diffraction element and the second diffraction element; placing and affixing the exposed first diffraction element on and to one of surfaces of a support material; and placing and affixing the exposed second diffraction element on and to the other surface of the support material, facing across the void.

### Effects of the Invention

According to the present technology, it is possible to provide a composite diffraction element capable of preventing nonuniformity of an image due to, for example, a bubble and improving quality. Note that the effects described above are not necessarily limiting, and any of the effects described in the present description or other effects that can be grasped from the present description may be exerted in addition to or instead of the effects described above.

### BRIEF DESCRIPTION OF DRAWINGS

FIG. 1 is a schematic side view illustrating a composite diffraction element according to a first embodiment of the present technology;

FIG. 2 is a schematic plan view illustrating the composite diffraction element according to the first embodiment of the present technology;

FIG. 3 is a schematic diagram illustrating an example of a manufacturing process of the composite diffraction element according to the first embodiment of the present technology;

FIG. 4 is a schematic diagram illustrating an image display device using the composite diffraction element according to the first embodiment of the present technology;

FIG. 5 is a schematic side view illustrating a known composite diffraction element;

FIG. 6 is an image illustrating a state in which a bubble is present inside the known composite diffraction element;

FIG. 7 is an image illustrating a state of the inside of the composite diffraction element according to the first embodiment of the present technology;

FIG. 8 is a schematic side view illustrating a modification of the composite diffraction element according to the first embodiment of the present technology;

FIG. 9 is an exploded perspective view illustrating a modification of the composite diffraction element according to the first embodiment of the present technology;

FIG. 10 is a schematic plan view illustrating the modification of the composite diffraction element according to the first embodiment of the present technology;

FIG. 11 is a perspective view illustrating an image display device according to a second embodiment of the present technology;

FIG. 12 is a perspective view illustrating an example of use of the image display device according to the second embodiment of the present technology;

FIG. 13 is a perspective view illustrating an example of use of an image display device according to a third embodiment of the present technology;

FIG. 14 is a perspective view illustrating an image display device according to a fourth embodiment of the present technology; and

FIG. 15 is a perspective view illustrating an image display device according to a fifth embodiment of the present technology.

### MODE FOR CARRYING OUT THE INVENTION

Preferred modes for carrying out the present technology are described hereinafter with reference to the drawings. Embodiments described below reveal examples of representative embodiments of the present technology, and any embodiments can be combined. Furthermore, the scope of the present technology is not narrowly construed on the basis of the embodiments. Note that a description is given in the following order:
1. First Embodiment
(1) Example of Configuration of Composite Diffraction Element
(2) Example of Method for Manufacturing Composite Diffraction Element
(3) Example of Configuration of Image Display Device
(4) Comparison with Known Composite Diffraction Element
(5) Modifications of Composite Diffraction Element
2. Second Embodiment
3. Third Embodiment
4. Fourth Embodiment
5. Fifth Embodiment

### 1. FIRST EMBODIMENT

### (1) Example of Configuration of Composite Diffraction Element

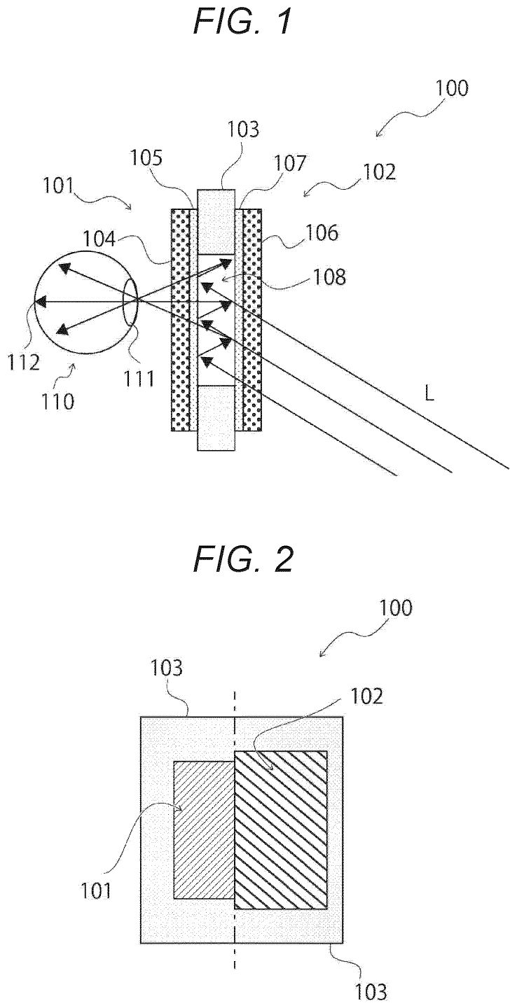

Firstly, an example of the configuration of a composite diffraction element according to a first embodiment of the present technology is described with reference to FIGS. 1 and 2. FIG. 1 is a schematic side view illustrating an example of the configuration of a composite diffraction element 100 according to the embodiment. FIG. 2 is a schematic plan view of the partially cutaway composite diffraction element 100 according to the embodiment, illustrating an example of the configuration thereof. FIG. 2 is a cross-sectional view in which a second diffraction element 102 and a support body 103 are cut away on the left side of the page with respect to a broken line in an up-and-down direction in a central portion of the page.

As illustrated in FIGS. 1 and 2, as an example, the composite diffraction element 100 includes a reflective first diffraction element 101 and the second diffraction element 102, the diffraction elements 101 and 102 each having a reflection surface that reflects light, and the support body 103 placed between each of the diffraction elements 101 and 102.

The first diffraction element 101 includes a protective layer 104 and a photosensitive material layer 105 on which the reflection surface is formed. The protective layer 104 acts as protection for the very thin photosensitive material layer 105, and, for example, a transparent protective sheet is used as the protective layer 104. For example, an organic material or the like is used as the photosensitive material layer 105, and the photosensitive material layer 105 has a thickness of several μm to several dozen μm.

Similarly, the second diffraction element 102 includes a protective layer 106 and a photosensitive material layer 107. In the embodiment, the photosensitive material layer 105 and the photosensitive material layer 107 are affixed to and in contact with the side surfaces of the support body 103. However, the embodiment is not limited to this, and the protective layer 104 and the protective layer 106 may be affixed to and in contact with the side surfaces of the support body 103 of a support body.

As an example, the first diffraction element 101 and the second diffraction element 102 are volume hologram elements, and are placed face-to-face in such a manner that their respective reflection surfaces for a light beam L are caused to face each other substantially parallel via the support body 103. Furthermore, the first diffraction element 101 and the second diffraction element 102 have low strength by themselves, and have insufficient strength to perform interference exposure in the process of producing a hologram, and insufficient strength for a finished product to be used by a user. Hence, the first diffraction element 101 and the second diffraction element 102 are held by the support body 103 with a certain level of strength and transparency.

As an example, the support body 103 has a void 108, which is rectangular in plan view, in a central portion being a portion where the projected light beam L passes. The void 108 is filled with gas such as an atmosphere. In the composite diffraction element 100, each of the diffraction elements 101 and 102 are placed facing each other across the void 108, and are mechanically held in contact with the support body 103 at a portion other than the void 108. Therefore, the support body 103 and the reflection surfaces of each of the diffraction elements 101 and 102 are optically uniformly connected, and the void 108 is sealed by the diffraction elements 101 and 102.

As an example, the composite diffraction element 100 is used for, for example, eyewear. The light beam L is projected from, for example, a light source unit that generates coherent light, such as a semiconductor laser (LD), a superluminescent diode (SLD), or a light emitting diode (LED). The first diffraction element 101 and the second diffraction element 102, which are included in the composite diffraction element 100, are each formed as a volume hologram having grating angle and spacing where the Bragg (Bragg) condition is satisfied with respect to a specific incident angle and incident wavelength. Then, the first diffraction element 101 and the second diffraction element 102 have a function of transmitting the projected light beam L while reflecting and diffracting the light beam L selectively.

The first diffraction element 101 is provided with a diffraction element structure that reflects, at a specific angle, the light beams L that are incident parallel, and the second diffraction element 102 is provided with a diffraction structure that reflects the light beams L that are incident parallel, at an angle that concentrates the light beams L on a specific position.

As illustrated in FIG. 1, the light beams L at the specific angle and with a specific wavelength, the light beams L having been projected from the outside into the composite diffraction element 100, are transmitted through the second diffraction element 102, then pass through the atmosphere in the void 108, and are diffracted and reflected at the specific angle on the reflection surface of the first diffraction element 101. The diffracted and reflected light beams L pass through the atmosphere in the void 108, are diffracted and reflected again at the specific angle on the reflection surface of the second diffraction element 102, and further pass through the atmosphere in the void 108 to proceed to the first diffraction element 101. The light beams L that have reached the first diffraction element 101 are transmitted through the first diffraction element 101 and are emitted out of the composite diffraction element 100, and are concentrated at a position at a certain distance. At this point in time, the light beams L projected into the composite diffraction element 100 do not pass through the support body 103 at all.

The light beams L then enter an eyeball 110 of the user by placing a pupil 111 of the eyeball 110 at the concentration position. The light beams L that have entered the eyeball 110 are projected onto a retina 112. As a result, the user can visually recognize the light beams L as video.

Here, the volume hologram has a feature that reflection and diffraction characteristics include strong wavelength and angular selection systems. Hence, light at an angle and with a wavelength other than the set angle and wavelength is allowed to be transmitted through the volume hologram without being diffracted. Therefore, even if the composite diffraction element 100 is structured in such a manner that the reflection surfaces face each other, the light beams L are not reflected and diffracted on an unnecessary surface. Furthermore, the user can experience the superimposition of the projected video simultaneously with visual recognition of the light beams L from real space.

Note that, in order to efficiently project the projected light beams L onto the retina 112, it is better for the first diffraction element 101 and the second diffraction element 102 to have higher diffraction efficiency and to have a uniform efficiency value over the surface onto which the light beams L are projected. In addition, the reflection surfaces of the first diffraction element 101 and the second diffraction element 102 are required to be as smooth as possible and to have less physical deformation and the like. Furthermore, in a case where the composite diffraction element 100 has an eyeglass frame shape and is used on, for example, the face, it is necessary to be as light as possible.

### (2) Example of Method for Manufacturing Composite Diffraction Element

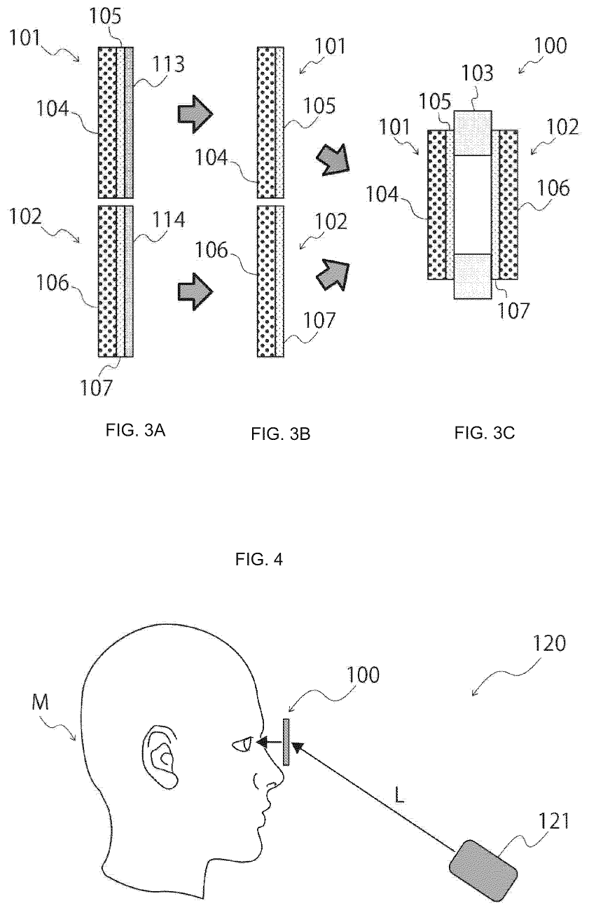

Next, an example of a method for manufacturing the composite diffraction element 100 according to the embodiment is described with reference to FIG. 3. FIG. 3 is a schematic diagram illustrating an example of a manufacturing process of the composite diffraction element 100. FIG. 3A illustrates the step of interference exposure of the diffraction elements. FIG. 3B illustrates the step of peeling off the diffraction elements. FIG. 3C illustrates the step of affixing the diffraction elements to the support body 103.

Firstly, in the first step illustrated in FIG. 3A, in order to provide different grating spacing pitches according to interference exposure, the unexposed first diffraction element 101 and second diffraction element 102 are affixed to, or coated on, a temporary holding material 113 and a temporary holding material 114, respectively. Thereafter, the unexposed first diffraction element 101 and second diffraction element undergo interference exposure separately. Therefore, interference exposure can be performed without mutually influencing the first diffraction element 101 and the second diffraction element 102.

Next, in the second step illustrated in FIG. 3B, the first diffraction element 101 and the second diffraction element 102, which have undergone interference exposure, are peeled off from the holding material 113 and the holding material 114.

In the third step illustrated in FIG. 3C, the peeled first diffraction element 101 and second diffraction element 102 are then affixed to two side surfaces of the support body 103, respectively.

The composite diffraction element 100 has the void 108 in the support body 103; consequently, it is possible to avoid the mixing of minute dust in between the first diffraction element 101 and the second diffraction element 102, and the support body 103 during the peeling operation in the second step and the reaffixing operation in the third step, and to avoid occurrence of a partial distortion or warp in the shape upon affixing the photosensitive material layer 105 and the photosensitive material layer 107 to the support body 103. Therefore, it is possible to prevent the generation of a bubble resulting from partial mixing of an air layer, and to prevent partial breakage of the optical connections between the photosensitive material layer 105 and the photosensitive material layer 107, and the support body 103.

Furthermore, there may be a case where it is necessary to fix the mutual positions of the reflection surfaces of the first diffraction element 101 and the second diffraction element 102 in the horizontal direction, while adjusting the mutual positions to satisfy a required accuracy condition when the first diffraction element 101 and the second diffraction element 102 are caused to face each other. In this case, the composite diffraction element 100 can prevent the risk of generation of a bubble even if repeated operations occur, such as repeeling and reaffixing after the first diffraction element 101 and the second diffraction element 102 are affixed to the support body 103.

In the composite diffraction element 100 according to the embodiment, the optical connection between the first diffraction element 101 and the second diffraction element 102, and the void 108 located in the portion through which the light beams L projected from the outside pass is always constant. As a result, no disturbance in the diffracted light due to the nonuniform connection occurs at all in principle. Hence, the composite diffraction element 100 shakes off concerns about quality reduction due to, for example, minute dust that is present during the manufacturing process and the inclusion of an atmosphere during the affixing operation. Therefore, the composite diffraction element 100 can prevent nonuniformity of an image due to, for example, a bubble, and improve quality.

### (3) Example of Configuration of Image Display Device

Next, an example of the configuration of an image display device using the composite diffraction element 100 according to the embodiment is described with reference to FIG. 4. FIG. 4 is a schematic diagram illustrating an image display device 120 using the composite diffraction element 100.

As illustrated in FIG. 4, as an example, the image display device 120 is a retinal scan projector, and includes the composite diffraction element 100 and a light source unit 121 that emits the light beam L. The light source unit 121 acts as an image forming unit that forms an image that is visually recognized by a user M.

In the image display device 120, the light source unit 121 is placed at a position deviating from the axis of the line-of-sight on the front side of the user M, and the composite diffraction element 100 is placed immediately above the pupil of the user M. The composite diffraction element 100 is provided with a characteristic of selectively diffracting a light beam with a light source wavelength. The light beam L projected from the light source unit 121 is diffracted by the composite diffraction element 100 to bend the traveling direction of the light beam L. The light beam L is then projected toward the pupil of the user M.

As described above, the composite diffraction element 100 and the image display device 120 according to the embodiment can exert the following effects: In other words, it is possible to reduce the risk of quality reduction caused by, for example, dust, and a bubble due to the inclusion of the atmospheric layer in the void 108 and to improve workability in an operation to be performed when after undergoing interference exposure individually, each of the diffraction elements 101 and 102 are peeled off from the temporary holding materials 113 and 114 and reaffixed to the support body 103.

Furthermore, it is possible to reduce the risk of quality reduction in the event of occurrence of a repair operation such as reaffixing after peeling and to improve workability. Furthermore, a reduction in light transmittance due to scattering and absorption upon transmission through the support body 103 does not occur. Consequently, the transmittance of the composite diffraction element 100 can be increased. Furthermore, the support body 103 includes the void 108. Consequently, it is possible to relatively reduce the weight of the composite diffraction element 100. Furthermore, it is possible to integrate the support body 103 with a mechanism that holds the composite diffraction element 100 in front of the eye of the user M. Moreover, the transmitted light beam L does not pass through the support body 103. Consequently, the support body 103 does not need to be transparent, so that the material and color options increase, and product variations of the image display device 120 such as a retinal projection projector can be increased.

### (4) Comparison with Known Composite Diffraction Element

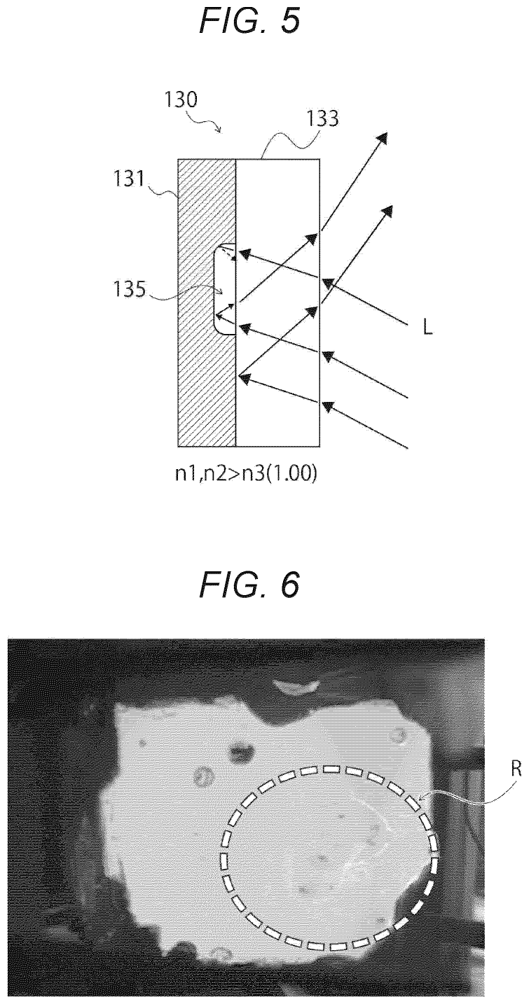

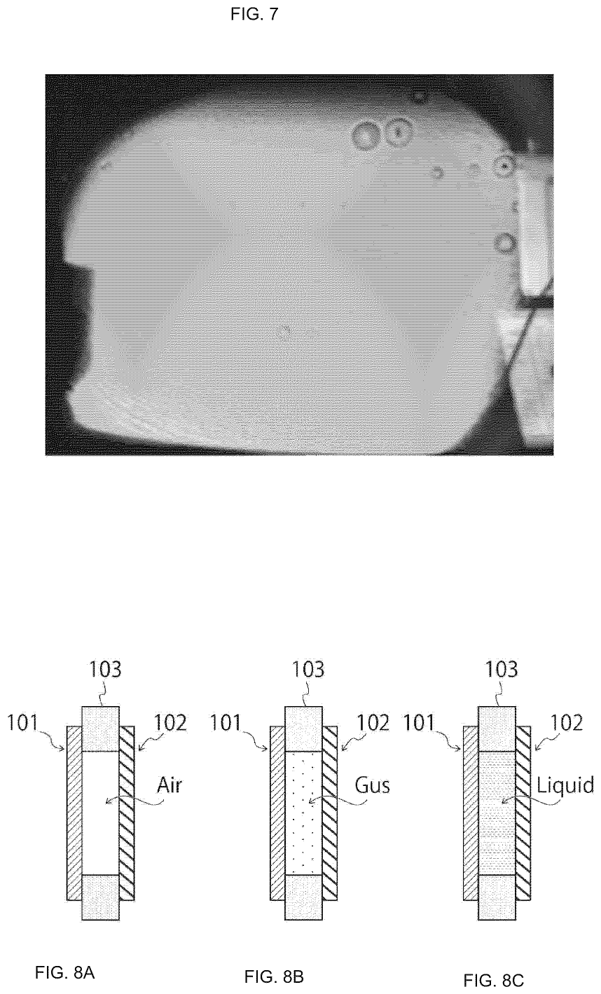

Next, a comparison between a known composite diffraction element and the composite diffraction element 100 is described with reference to FIGS. 5 to 7. FIG. 5 is a schematic side view illustrating a known composite diffraction element 130. FIG. 6 is an image illustrating a state in which a bubble is present inside the known composite diffraction element 130. FIG. 7 is an image illustrating a state of the inside of the composite diffraction element 100 according to the embodiment.

As illustrated in FIG. 5, as an example, the known composite diffraction element 130 includes a diffraction element 131 and a support body 133 to which the diffraction element 131 is affixed. No void is formed in the support body 133. Consequently, a bubble 135 is generated at a boundary surface between the diffraction element 131 and the support body 133 when the diffraction element 131 is affixed to the support body 133.

Here, it is assumed that the refractive index of the diffraction element 131 is n1, the refractive index of the support body 103 such as glass or transparent plastic is n2, and the refractive index of an atmosphere inside the bubble 135 is n3 (1.00). Then, there is a significant difference between n1 and n2, and n3. Consequently, if an atmospheric layer resulting from the bubble 135 exists in part when the light beam L passes through the boundary between the diffraction element 131 and the support body 103, then an unintended change occurs in the diffraction angle in that place, and an influence such as nonuniformity of the image occurs. The influence of the bubble 135 is considered to be large especially on the reflection surface.

As illustrated in FIG. 6, it can be seen that the bubble 135 was generated at the boundary surface between the diffraction element 131 and the support body 133, the boundary surface being located in a region R, when the diffraction element 131 was affixed to the support body 133. Therefore, when the composite diffraction element 130 is used, an influence such as the nonuniformity of the image may occur.

On the other hand, FIG. 7 illustrates an image of diffracted light of when red light was projected from the outside into the composite diffraction element 100 obtained by adding the diffraction elements 101 and 102 to the support body 103 having the void 108. As illustrated in FIG. 7, in the composite diffraction element 100, the nonuniformity of the image due to the mixing of a bubble and dust or the like is not observed in any region. Therefore, the composite diffraction element 100 can generate a uniform image.

### (5) Modifications of Composite Diffraction Element

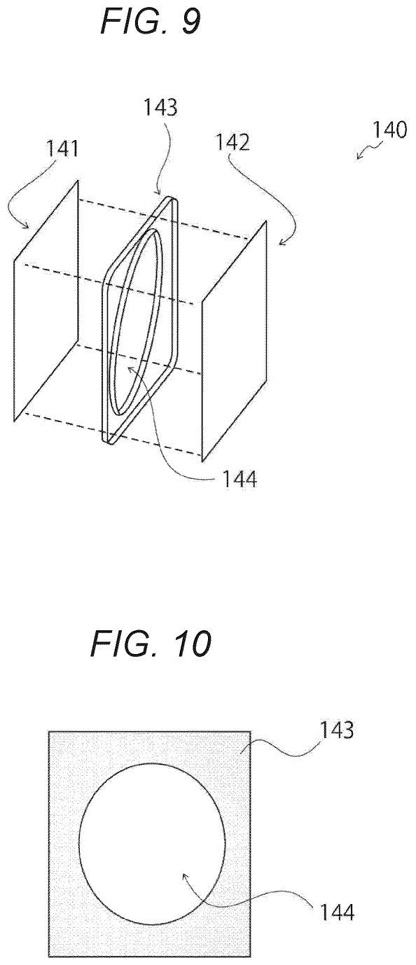

Next, modifications of the composite diffraction element 100 according to the embodiment are described with reference to FIGS. 8 to 10. FIG. 8 is a schematic side view illustrating a modification of the composite diffraction element 100. FIG. 9 is an exploded perspective view illustrating a modification of the composite diffraction element 100. FIG. 10 is a schematic plan view illustrating the modification of the composite diffraction element 100.

As illustrated in FIG. 8A, the void 108 of the support body 103 according to the embodiment is filled with an atmosphere (air) at approximately one atmospheric pressure equal to that of the outside air. However, the void 108 may be replaced with a gas-phase (gas) or liquid-phase (liquid) substance other than the atmosphere instead of the atmosphere. For example, as illustrated in FIG. 8B, in a case where the diffraction elements 101 and 102 change in characteristics due to long-term exposure of the reflection surfaces thereof to a specific component (for example, water vapor or oxygen molecules) included in the atmosphere, it is conceivable that an inert gas such as nitrogen or argon replaces the atmosphere to be filled. Furthermore, as illustrated in FIG. 8C, in a situation where the diffraction elements 101 and 102 are deformed under an external pressure due to the void 108 in the gas phase, a liquid phase such as an immersion oil may be filled in order to prevent deformation.

On the other hand, the void 108 of the support body 103 according to the embodiment has a rectangular shape in plan view. However, the shape of the void 108 is not limited to a rectangular shape, and may be, for example, a circular shape, an elliptical shape, a polygonal shape, or a U shape as long as the void 108 has a size that allows all the light beams L pass therethrough.

For example, FIGS. 9 and 10 illustrate a case where the void 108 has a circular shape in plan view. As illustrated in FIGS. 9 and 10, a composite diffraction element 140 according to the modification of the embodiment includes a first diffraction element 141 and a second diffraction element 142, and a support body 143 placed between the first diffraction element 141 and the second diffraction element 142.

The support body 103 has a void 108 having a circular shape in plan view. In this case, the composite diffraction element 140 can have effects similar to those of the composite diffraction element 100 according to the embodiment as long as the support body 103 has a size that allows all the light beams L to pass therethrough. Furthermore, the support body 103 does not transmit light and does not need to be transparent. Consequently, the degree of flexibility in the selection of the shape and the material is high.

### 2. SECOND EMBODIMENT

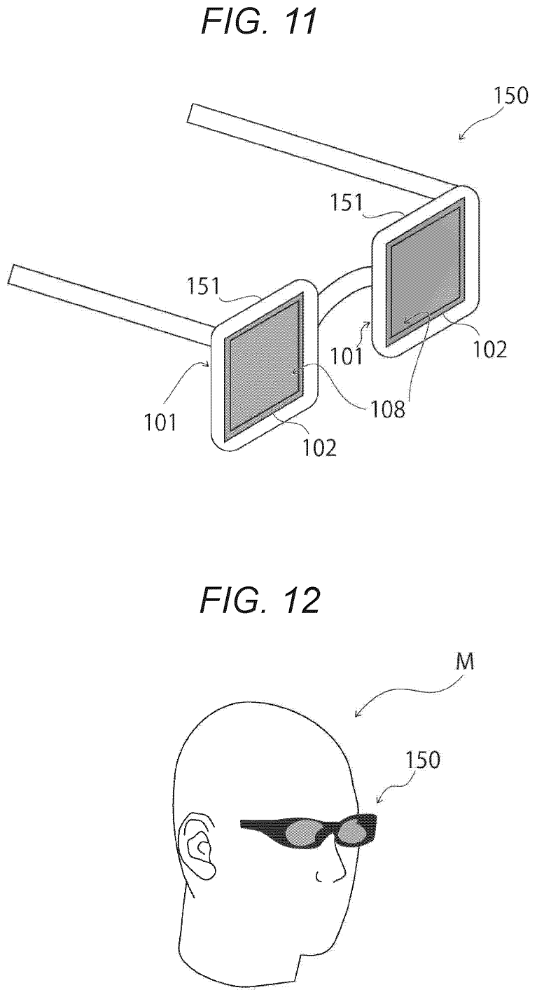

Next, an example of the configuration of an image display device according to a second embodiment of the present technology is described with reference to FIGS. 11 and 12. FIG. 11 is a perspective view illustrating an example of the configuration of an image display device 150 according to the embodiment. FIG. 12 is a perspective view illustrating an example of use of the image display device 150 according to the embodiment. The image display device 150 can be applied to an eyeglass-shaped frame.

As illustrated in FIG. 11, the image display device 150 includes first diffraction elements 101, second diffraction elements 102, and an eyeglass-shaped frame 151. The first diffraction element 101 and the second diffraction element 102 are affixed directly to two side surfaces of each of glass portions of the eyeglass-shaped frame 151. In the image display device 150, support bodies each supporting the first diffraction element 101 and the second diffraction element 102 are integral with the eyeglass-shaped frame 151 that is a holding member that holds the first diffraction elements 101 and the second diffraction elements 102 at predetermined positions, and the glass portions of the eyeglass-shaped frame 151 act as the support bodies. A void 108 having a rectangular shape in plan view is formed in each of the glass portions of the eyeglass-shaped frame 151. Furthermore, the image display device 150 includes an image forming unit that forms an image that is visually recognized by a user.

The image display device 150 according to the embodiment can, for example, prevent the nonuniformity of an image due to the mixing of, for example, a bubble into the glass portions of the eyeglass-shaped frame 151, and improve the quality of the image display device 150, as in the composite diffraction element 100 according to the first embodiment. Furthermore, in the image display device 150, the eyeglass-shaped frame 151 is integral with the support bodies each supporting the first diffraction element 101 and the second diffraction element 102; therefore, there is no need to provide support bodies separately from the eyeglass-shaped frame 151, and a reduction in weight can be promoted. Moreover, in the image display device 150, the eyeglass-shaped frame 151 to which the composite diffraction elements each including the first diffraction element 101 and the second diffraction element 102 are attached can be used on the face, as illustrated in FIG. 12. Consequently, the composite diffraction elements can be placed immediately above the pupils with accuracy.

### 3. THIRD EMBODIMENT

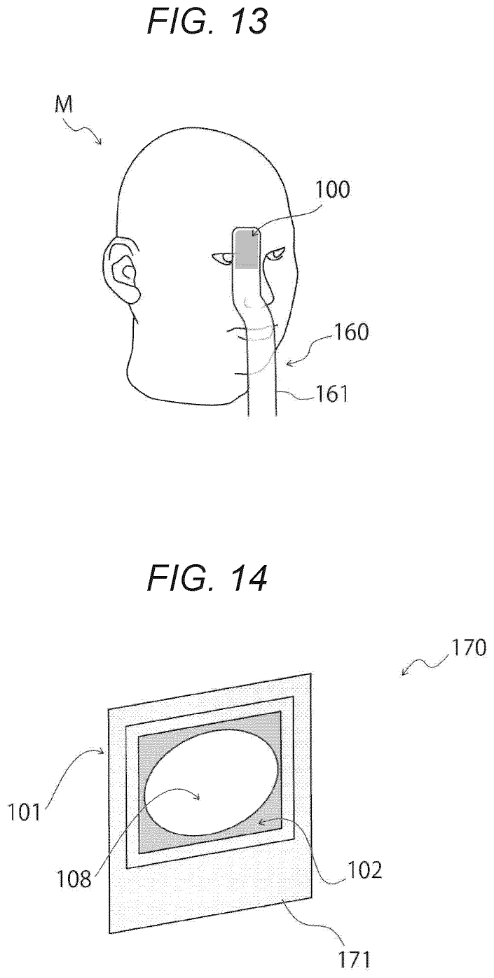

Next, an example of the configuration of an image display device according to a third embodiment of the present technology is described with reference to FIG. 13. FIG. 13 is a perspective view illustrating an example of use of an image display device 160 according to the embodiment. The image display device 160 can install a diffraction element independently near a user's face.

As illustrated in FIG. 13, the image display device 160 includes the composite diffraction element 100 according to the first embodiment, and a support body 161 that supports the composite diffraction element 100. As an example, the support body 161 includes a slim thin metal plate, and have the composite diffraction element 100 attached to a distal end of the metal plate in an extending direction thereof. Furthermore, the image display device 160 includes an image forming unit that forms an image that is visually recognized by a user.

The support body 161 can be bent in accordance with the shape of the user's face. During use, the image display device 160 can position the composite diffraction element 100 near the user's eye to be installed independently.

The image display device 160 according to the embodiment can, for example, prevent the nonuniformity of an image due to the mixing of, for example, a bubble into the composite diffraction element 100, and improve the quality of the image display device 160, as in the image display device 150 according to the second embodiment. Furthermore, the image display device 150 is installed as an independent object in a space, and the user himself/herself can bring his/her face close to the composite diffraction element 100, and move the pupil to an appropriate position.

### 4. FOURTH EMBODIMENT

Next, an example of the configuration of an image display device according to a fourth embodiment of the present technology is described with reference to FIG. 14. FIG. 14 is a perspective view illustrating an example of use of an image display device 170 according to the embodiment. The image display device 170 can be applied to a card-shaped support body.

As illustrated in FIG. 14, the image display device 170 includes a first diffraction element 101, a second diffraction element 102, and a card-shaped support body 171. As an example, a circular void 108 is formed in a part of the support body 171. The first diffraction element 101 and the second diffraction element 102 are affixed to two side surfaces of the support body 171 at a position where the void 108 is formed. Furthermore, the image display device 170 includes an image forming unit that forms an image that is visually recognized by a user.

The image display device 170 according to the embodiment can, for example, prevent the nonuniformity of an image due to the mixing of, for example, a bubble into the void 108, and improve the quality of the image display device 170, as in the image display device 150 according to the second embodiment. Furthermore, the entire shape of the image display device 170 is a card shape. Consequently, the image display device 170 can be easily carried by hand.

### 5. FIFTH EMBODIMENT

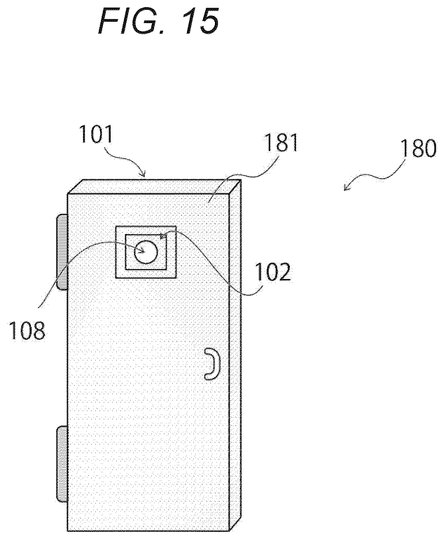

Next, an example of the configuration of an image display device according to a fifth embodiment of the present technology is described with reference to FIG. 15. FIG. 15 is a perspective view illustrating an example of use of an image display device 180 according to the embodiment. The image display device 180 can be applied to a door-shaped support body.

As illustrated in FIG. 15, the image display device 180 includes a first diffraction element 101, a second diffraction element 102, and a door-shaped support body 181. As an example, a circular void 108 is formed in an upper part of the support body 181. The first diffraction element 101 and the second diffraction element 102 are affixed to two side surfaces of the support body 181 at a position where the void 108 is formed. Furthermore, the image display device 180 includes an image forming unit that forms an image that is visually recognized by a user.

The image display device 180 according to the embodiment can, for example, prevent the nonuniformity of an image due to the mixing of, for example, a bubble into the void 108, and improve the quality of the image display device 180, as in the image display device 150 according to the second embodiment. Furthermore, the image display device 180 uses the position of the void 108 to which the first diffraction element 101 and the second diffraction element 102 are affixed, as a small window of the door, and consequently can provide specific information on the opposite side of the door only to a specific user.

Note that the present technology can take the following configurations:

(1)

A composite diffraction element including:
at least two diffraction elements each having a reflection surface that reflects light; and
a support body placed between the diffraction elements, the support body having a void,
in which each of the diffraction elements are placed, facing each other across the void.
   (2)

The composite diffraction element according to (1), in which the diffraction elements are reflective diffraction elements, and transmit projected light while diffracting the projected light selectively.

(3)

The composite diffraction element according to (1) or (2), in which the diffraction elements are volume hologram elements each having a protective layer and a photosensitive material layer on which the reflection surface is formed.

(4)

The composite diffraction element according to any of (1) to (3), in which each of the diffraction elements have the light reflection surfaces facing each other substantially parallel via the support body.

(5)

The composite diffraction element according to any of (1) to (4), in which the void is filled with gas such as air or an inert gas, or liquid such as an immersion oil.

(6)

The composite diffraction element according to any of (1) to (5), in which a planar shape of the void is any of a circular shape, an elliptical shape, a polygonal shape, or a U shape.

(7)

The composite diffraction element according to any of (1) to (6), in which the support body is integral with a holding member that holds the composite diffraction element at a predetermined position.

(8)

An image display device including:
at least two diffraction elements on each of which a reflection surface that reflects light is formed;
a support body placed between each of the diffraction elements, the support body having a void; and
an image forming unit,
in which each of the diffraction elements are placed, facing each other across the void.
   (9)

A method for manufacturing a composite diffraction element, the method including the steps of:
affixing a first diffraction element to a first holding material and affixing a second diffraction element to a second holding material;
exposing the first diffraction element affixed to the first holding material;
exposing the second diffraction element affixed to the second holding material;
forming a void in a support body supporting the first diffraction element and the second diffraction element;
placing and affixing the exposed first diffraction element on and to one of surfaces of a support material; and
placing and affixing the exposed second diffraction element on and to the other surface of the support material, facing across the void.

### REFERENCE SIGNS LIST

100, 130, 140 Composite diffraction element
101, 102, 131, 141, 142 Diffraction element
103, 133, 143, 151, 161, 171, 181 Support body
104, 106 Protective layer
105, 107 Photosensitive material layer
108, 144 Void
110 Eyeball
111 Pupil
112 Retina
120, 150, 160, 170, 180 Image display device
121 Light source unit
135 Bubble
L Light beam
M User
R Region

1. A composite diffraction element comprising:
at least two diffraction elements each having a reflection surface that reflects light; and
a support body placed between each of the diffraction elements, the support body having a void,
wherein each of the diffraction elements are placed, facing each other across the void.

2. The composite diffraction element according to claim 1, wherein the diffraction elements are reflective diffraction elements, and transmit projected light while diffracting the projected light selectively.

3. The composite diffraction element according to claim 1, wherein the diffraction elements are volume hologram elements each having a protective layer and a photosensitive material layer on which the reflection surface is formed.

4. The composite diffraction element according to claim 1, wherein each of the diffraction elements have the light reflection surfaces facing each other substantially parallel via the support body.

5. The composite diffraction element according to claim 1, wherein the void is filled with gas such as air or an inert gas, or liquid such as an immersion oil.

6. The composite diffraction element according to claim 1, wherein a planar shape of the void is any of a circular shape, an elliptical shape, a polygonal shape, or a U shape.

7. The composite diffraction element according to claim 1, wherein the support body is integral with a holding member that holds the composite diffraction element at a predetermined position.

8. An image display device comprising:
at least two diffraction elements on each of which a reflection surface that reflects light is formed;
a support body placed between each of the diffraction elements, the support body having a void; and
an image forming unit,
wherein each of the diffraction elements are placed, facing each other across the void.

9. A method for manufacturing a composite diffraction element, the method comprising steps of:
affixing a first diffraction element to a first holding material and affixing a second diffraction element to a second holding material;
exposing the first diffraction element affixed to the first holding material;
exposing the second diffraction element affixed to the second holding material;
forming a void in a support body supporting the first diffraction element and the second diffraction element;
placing and affixing the exposed first diffraction element on and to one of surfaces of a support material; and
placing and affixing the exposed second diffraction element on and to the other surface of the support material, facing across the void.
